(19) United States
(12) Patent Application Publication
(10) Pub. No.: US 2013/0166543 A1
(43) Pub. Date: Jun. 27, 2013

(54) CLIENT-BASED SEARCH OVER LOCAL AND REMOTE DATA SOURCES FOR INTENT ANALYSIS, RANKING, AND RELEVANCE

(71) Applicants: Brian MacDonald, Bellevue, WA (US); Mira Lane, Redmond, WA (US); Bhrighu Sareen, Redmond, WA (US); Arun D. Poondi, Hyderabad (IN); Gaurang Prajapati, New York City, NY (US); Karthik Gopal, Hyderabad (IN)

(72) Inventors: Brian MacDonald, Bellevue, WA (US); Mira Lane, Redmond, WA (US); Bhrighu Sareen, Redmond, WA (US); Arun D. Poondi, Hyderabad (IN); Gaurang Prajapati, New York City, NY (US); Karthik Gopal, Hyderabad (IN)

(73) Assignee: Microsoft Corporation, Redmond, WA (US)

(21) Appl. No.: 13/334,062

(22) Filed: Dec. 22, 2011

(51) Int. Cl. G06F 17/30

(52) U.S. Cl. 707/723; 707/E17.084

(57) ABSTRACT

A search engine that resides on a local computer to enable query intent analysis, results ranking, and relevance processing over data of both local and remote data sources. The architecture also employs a global access component, which is a unified interface to disparate data discovery paradigms. The global access component provides access to corresponding disparate datasets of the paradigms for creating aggregation of information. A local search engine creates the aggregations of information from the disparate datasets via the global access component and processes a query against the aggregations of information to return search results.

### BACKGROUND

As technology continues to evolve content creation and publishing has becomes democratized whereby anyone in any location and on any device can be a content publisher (and perhaps a creator) by publishing the content over the Internet and social networks for consumption. Similarly, in a connected enterprise environment users can publish content over share services, etc., for internal enterprise consumption. However, this ability of the individual user to create and/or publish has manifested into silo'ed (compartmentalized) content visualization and provides a fractured view of the overall content universe for a given topic. Moreover, the underlying social aspects of the data are undiscoverable. A single overall search framework is lacking via which to interface and search the data of the corresponding paradigms. Consequently, the content consumer needs to be aware of the individual content storage and discovery paradigms under which the disparate data types are stored, such as a search engine for web content and the operating system search capability for local/enterprise content.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a search engine that resides on a local client device (e.g., computer, cell phone, etc.) that enables query intent analysis, results ranking, and relevance processing over data of both local and remote data sources. The data sources include, but are not limited to, local data (e.g., hard drives, flash drives, documents, user profile information, local networks such as home networks, other local user machines and devices such as a desktop, laptop, cell phone, tablet, etc., network data sources such as enterprise data repositories and enterprise user machines/devices, and web-based data sources such as social networks and websites, for example. The local results can be augmented with the network results, yet the local results and the network results can also be segregated.

The architecture also employs a global access component, which is a unified interface to disparate data discovery paradigms. The global access component provides access to corresponding disparate datasets of the paradigms for creating aggregations of information. A local search component creates the aggregations of information from the disparate datasets via the global access component and processes a query against the aggregations of information to return search results. The local search component performs intent analysis of the query to derive query intent, ranking of the search results, and relevance processing of the search results based on the query intent.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a more detailed system having a local search component for query processing and internet analysis, ranking, and relevance processing.

FIG. 3 illustrates a search system of optional extraction techniques.

FIG. 4 illustrates a search system in accordance with the disclosed architecture.

FIG. 5 illustrates a system for generating website suggestions.

FIG. 6 illustrates a method in accordance with the disclosed architecture.

FIG. 7 illustrates further aspects of the method of FIG. 6.

FIG. 8 illustrates an alternative method in accordance with the disclosed architecture.

FIG. 9 illustrates further aspects of the method of FIG. 8.

FIG. 10 illustrates a block diagram of a computing system that executes a local search engine for query intent analysis, tanking, and relevance, as well as a global access to disparate datasets in accordance with the disclosed architecture.

### DETAILED DESCRIPTION

The disclosed architecture is a client-based search engine that resides on a local device (e.g., a computer, cell phone, tablet, etc.) and enables query intent analysis, results ranking, and relevance processing over data of both local and remote data sources. The data sources include, for example, client device data, enterprise-based data, and web-based data, as well as any social aspects that can be derived from/across one or more of these sources, and the social aspects provide a basis for making inferences about user searches such as user intent. For example, when a user logs-in to a social network, the data can relate to friends and family. When the user logs-in to a corporate network using corporate credentials, the data can relate to employee and professional connections.

Additionally, when the user accesses the corporate network, data such as emails, text messages, corporate search history, phone calls, corporate data, working group memberships, etc., can be accessed. In essence, the web graph, social graphs, and enterprise connected graphs from a people perspective and a data perspective can be searched across at least all these networks. Accordingly, the data types (e.g., office suite applications, communications applications, documents, etc.) of all these domains are of multiple different types.

Moreover, the architecture includes an application that can smartly invoke each fulfillment paradigm of the associated disparate datasets and provide the content consumer a holistic view of content across data silos.

Generally, a searchable index of information is created and published. A service aggregates the information for the user. Dominant terms and topics are extracted to categorize, group, and browse through the information aggregations. Thus, a single source of search is provided across the disparate data paradigms.

The search results are sorted based on relevancy of the information across the combined index. Variables used for computing relevance vary based on the usage context. For example, if the user is looking for a file the user recently modified, then the last modified date can be one of the highest relevance factors along with any search queries that the user may have provided.

The architecture finds all content across the information sources of the client system, enterprise, and web, as well as enterprise connections and social connections, and specifically, for example, related to a particular topic, identifies “hot” and/or trending topics from the information aggregated, identifies user interests, and suggests websites from the data.

A consolidated list of search history can be created across the browsers, web, and local search engines that enable the user to quickly re-find information.

A portable search profile (e.g., of a social relationships aspect) of the user (e.g., via opt-in) can be created that the user can then use any device of choice. The user can also opt to share the search profile with sites that have recommendation services such as for online retailers and shopping sites. The search profile is additional information that such sites can opt to use to improve recommendation services to their users. Additionally, sharing of the search profile can be incentivized by agreed-upon discounts for shopping, for example.

The architecture can be extended to use the aggregated information for automatic search query suggestions in other applications such as platform search, browser applications, and/or web search engines. Smart grouping and search capabilities can be used to integrate the results. Instant messaging applications, email applications, social applications, images, video, voice applications (e.g., VOIP) or any applications that depends on contact information can integrate with the merged contacts.

Moreover, cross-device scenarios are enabled by creating a web version that integrates with all cloud applications to create a unified index of the user's information.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

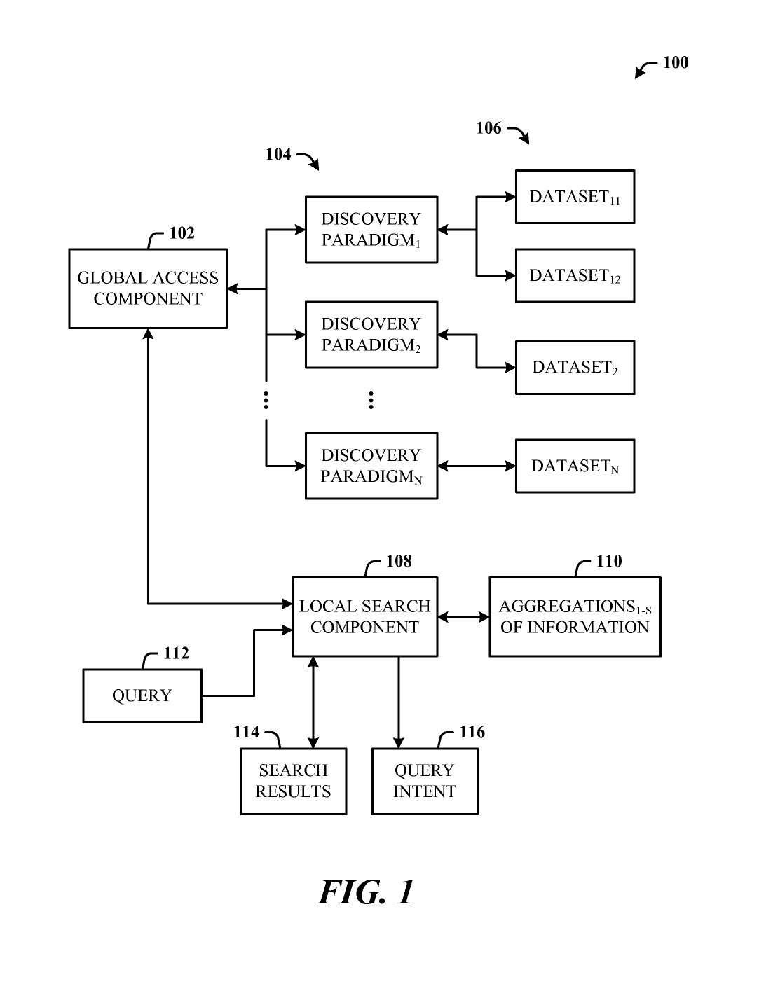

FIG. 1 illustrates a system 100 in accordance with the disclosed architecture. The system 100 includes a global access component 102 that is a unified interface to disparate data discovery paradigms 104. The global access component 102 provides access to corresponding disparate datasets 106 of the discovery paradigms 104. A local search component 108 creates aggregations 110 of information from the disparate datasets 106 via the global access component 102 and processes a query 112 against the aggregations 110 of information to return search results 114. The local search component 108 performs intent analysis of the query 112 to derive query intent, ranking of the search results, and relevance processing of the search results based on the query intent.

The local search component 108 creates a unified index of data from the aggregations 110 of information that include social aspects related to users and user data derived from the disparate datasets. The disparate data discovery paradigms 104 include client-based (local) paradigms and network-based paradigms (e.g., enterprise, Internet, social network, etc.). The search results 114 include client-based (local) results (e.g., of local applications, local storage devices, etc.) related to users and client data and network results (e.g., from web-based data sources, enterprise data sources, etc.) related to users and network-based data of the users. The search results 114 can be segregated as local results and network results, for presentation to the user. The disparate data discovery paradigms 104 relate to datasets associated with at least one of contacts, messages, documents, or websites, for example. The local search component 108 extracts dominant terms and topics (from the aggregations 110) to categorize, group, and browse through the datasets. The local search component 108 identifies trending (and hot) topics from a unified index of the aggregations of information. The local search component 108 identifies user interests via the aggregations 110 of information and suggests a website based on the user interests.

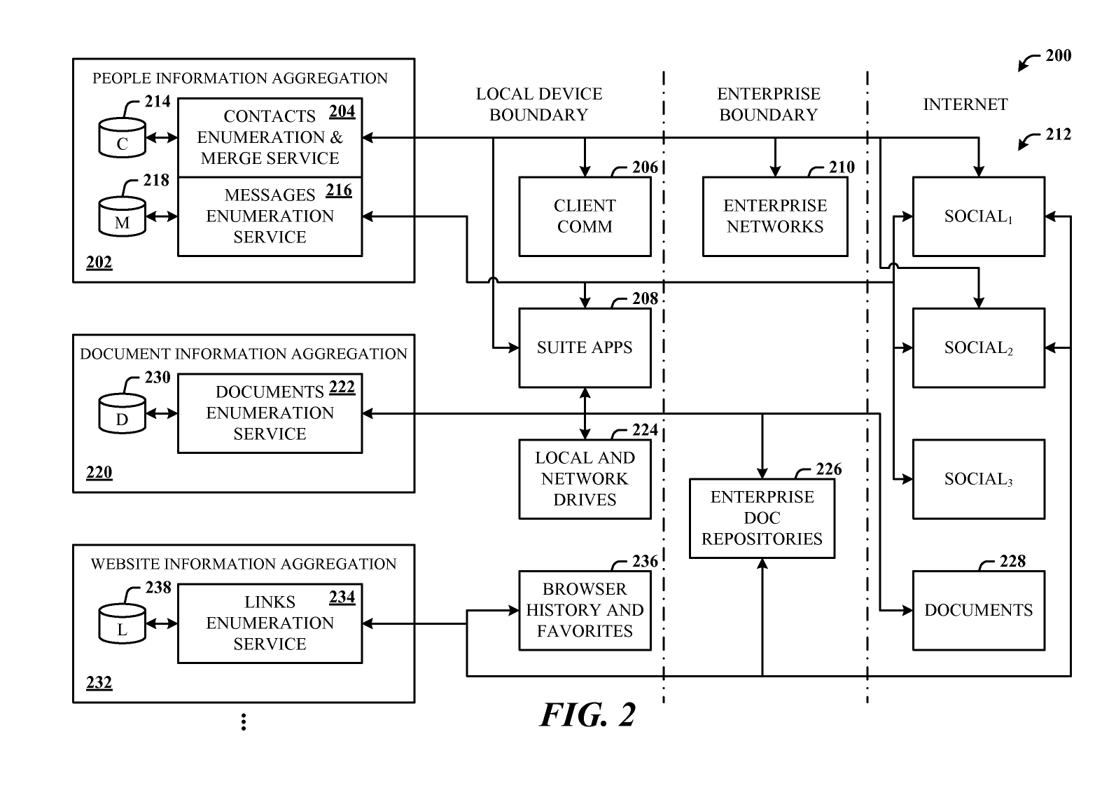

FIG. 2 illustrates a more detailed system 200 having a local search component for query processing and internet analysis, ranking, and relevance processing. The system 200 comprises a people aggregation component 202 for aggregating people information from disparate sources.

The people information component 202 can include a contacts enumeration and merge service 204 that accesses contact information from various local and remote sources. The service 204 aggregates all the user contacts from across different sources. The service 204 calls the APIs (application program interfaces) of the different source services to obtain the lists of contacts, and then performs a merge of the contacts based on common factors such as email identifier, first name+last name, etc.

The system 200 can include, but is not limited to, integration with client communications applications 206 (e.g., Lync™) for contacts in the local device boundary, suite applications 208 for contacts from email programs (e.g., Outlook™) in the local device boundary, contacts information from enterprise network 210 in the enterprise boundary, and contact information from social networks 212 (e.g., Social₁, Social₂, and Social₃) of the Internet, such as Skype™, Facebook™, Twitter™, and the like.

The system 200 can be extended to include other enterprise-level social networks, public networks such as Google+™, email clients such as Thunderbird™, web emails such gmail™, instant messaging clients such as Yahoo Messenger™, and so on. The service 204 can poll the APIs at predetermined intervals to obtain any additions or updates to the contacts. Thus, the service 204 creates a single database 214 of merged contacts from across the different sources.

The system 200 can also comprise a messages enumeration service 216 as part of the people aggregation component 202 for aggregating message information from the disparate sources. Here, the system 200 shows message extraction and processing from the suite applications 208 from email programs (e.g., Outlook™), for example, in the local device boundary, and messages information from social networks 212. The service 216 aggregates all messages from across the different sources. The service 216 calls the APIs for the different sources to provide a list of messages. While the service 216 downloads and creates a local copy of all the messages from the social networks, for performance reasons, the emails from an email program can be linked to in realtime.

The system 200 can be extended to include other enterprise-level social networks, public networks such as Google+™, email clients such as Thunderbird™, web emails such gmail™, instant messaging clients such as Yahoo Messenger™, and so on. The service 204 can poll the APIs at predetermined intervals to obtain any additions or updates to the messages. The service 216 creates a single database 218 of messages obtained from across the different sources.

The system 200 can also comprise a document aggregation component 220 that aggregates a list of documents from disparate sources. The document aggregation component 220 includes a documents enumeration service 222 that calls the APIs for the different sources to provide a list of documents. For performance reasons, the service 222 only maintains a list of pointers to the document locations along with the document metadata; however, this can be extended to caching or indexing the document. Here, the documents enumeration service 222 interfaces to the suite applications 208 and local/network drives 224 in the local device boundary, enterprise document repositories 226 in the enterprise boundary, and documents 228 on the Internet. The service 222 creates a single database 230 of the documents obtained from across the different sources. The service 222 polls the APIs at predetermined intervals to obtain any updates or additions to the documents and the document metadata.

The system 200 also comprises website information aggregation via a website aggregation component 232. The website aggregation component 232 includes a links enumeration service 234 that aggregates all links and sites from across the different sources. Here, the service 234 interfaces to browser history and favorites information 236 in the local device boundary, the enterprise doc repositories 226 in the enterprise boundary, and some of the social networks of the Internet. The service 234 calls the APIs for the different sources to extract and create a list of sites and links. The service 234 creates a single database 238 of links from across the different sources.

For performance reasons, the service 234 only maintains a list of links to the sites along with the associated metadata; however, this can include caching or indexing of the links. The service 234 polls the APIs at intervals to obtain any updates or additions to the links and the associated metadata.

The system can include other services, such as a media files aggregation component (not shown) that aggregates media files across sources. The component includes a service that aggregates all media files (e.g., photos, text, music, and movies) across heavily used sources. The service calls the APIs for the different sources to extract and create a grouped and browsable list of media files.

For performance reasons, the service can be configured to only maintain a list of links to the media files, along with any metadata the source provides. The metadata attributes are used to enable indexing as well as filters for browsing through the files. The system 200 can integrate with media players, photo applications, paint programs, photo enhancement programs, and folders commonly used to store photos and videos. As extensions, file metadata can be extracted from other heavily used tools such as online music services, etc. The service polls the source APIs at predetermined intervals to obtain any updates or additions to the files and the associated metadata.

All of the above content is categorized and grouped based on the dominant themes for the context to assist the user to browse through the information and get to the desired content. A topic can be the dominant theme across messages and documents, the sender may be a dominant theme in messages, site classification can be a dominant theme in links, and recency can be a dominant theme across contacts, messages, documents and sites.

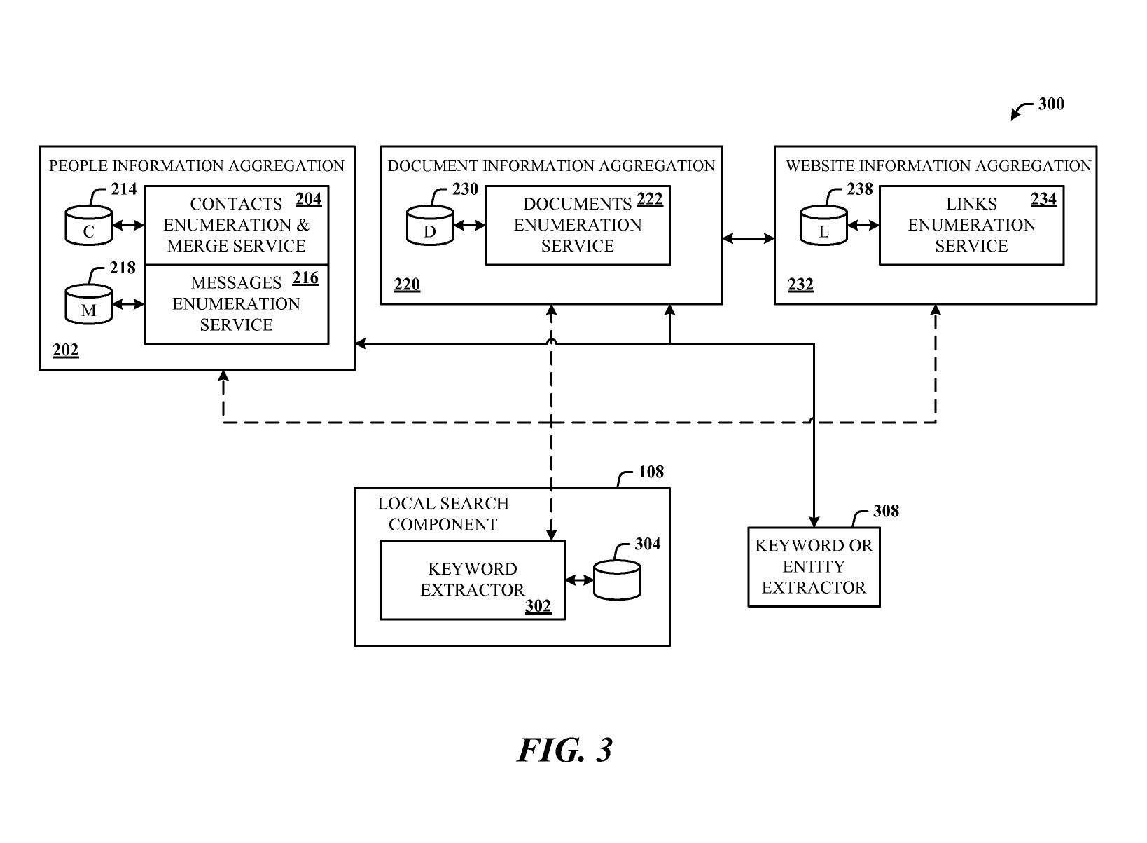

FIG. 3 illustrates a search system 300 of optional extraction techniques. In a first extraction implementation (denoted with dashed lines), the local search component 108 includes a keyword extraction service 302 and keyword frequency which can be utilized to extract dominant terms and identify topics to group the information. The grouped information is stored in a data store 304. In an alternative approach, an entity extraction service 306, newly created or an existing entity extraction service (local or cloud based) can be used to identify topics to group by.

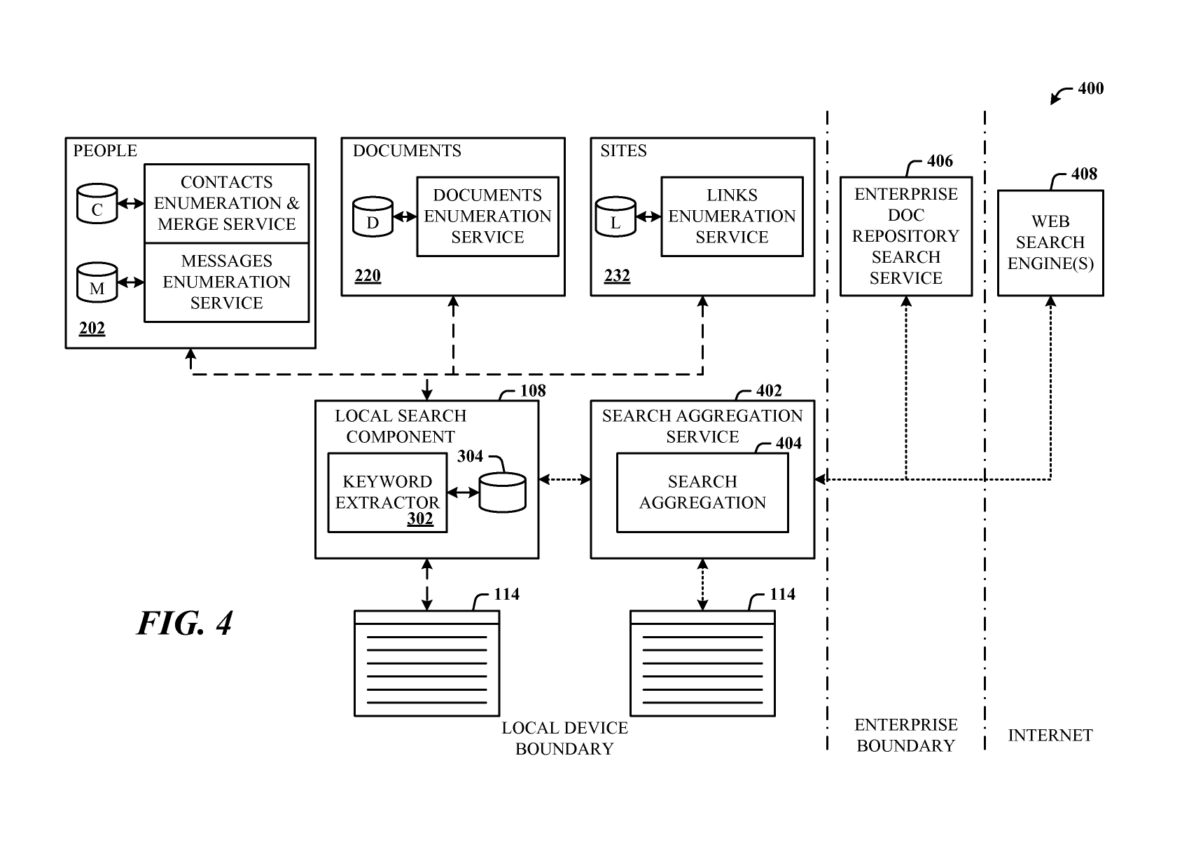

FIG. 4 illustrates a search system 400 in accordance with the disclosed architecture. The system 400 offers alternative options for searching across the information aggregations: a first system option using dashed interconnecting lines, and a second system option that uses the dotted interconnecting lines. The first system option employs the local search component 108 for keyword extraction of the people (contacts and messages), document, and sites in the local device boundary, to output the search results 114. The second system option employs a search aggregation service 402 to create a search aggregation 404 obtained not only from content in the local device boundary, but also via an enterprise document repository search service 406 in the enterprise boundary, and a web search engine 408 in the Internet boundary.

With respect to searching across the aggregation information, the local device search engine can be used or extended to search through the unified set of contacts and information. Searching through the document and link metadata is enabled, but can be extended to search the content of the document or the site content. This can be achieved in multiple ways, some of which are described as follows.

A temporary copy of the documents and site content can be created, and the operating system search capabilities (or any local device search engine) used to index and search through the content. This relates to the first system option.

Alternatively, or in combination therewith, the operating system search capabilities (or any local device search engine) can be used to search through local content, integrate with any existing enterprise search engines to search through content from the enterprise repository, and use web search engine(s) 408 to search through content of the website. An OpenSearch protocol can be used to achieve this. This relates to the second system option.

For a web version of the solution, a web search engine's indexing capability can be utilized, where the local search component 108 can be a web search engine. This relates to the first system option.

With respect to extracting entities from messages, documents, or sites to find related content, this is similar to the categorize-and-classify description above. When the user selects an item (e.g., email), the same system 300 of FIG. 3 can be used to extract dominant keywords from that item (e.g., email). The system 400 of FIG. 4 can then be employed to find all related content.

The system 300 employed for categorization, classification, or grouping of content for easy browsing can be used to identify the top dominant terms across the messages received by the user and the frequency of the terms across the messages. This helps identify the most discussed “hot” topics in the messages received by the user.

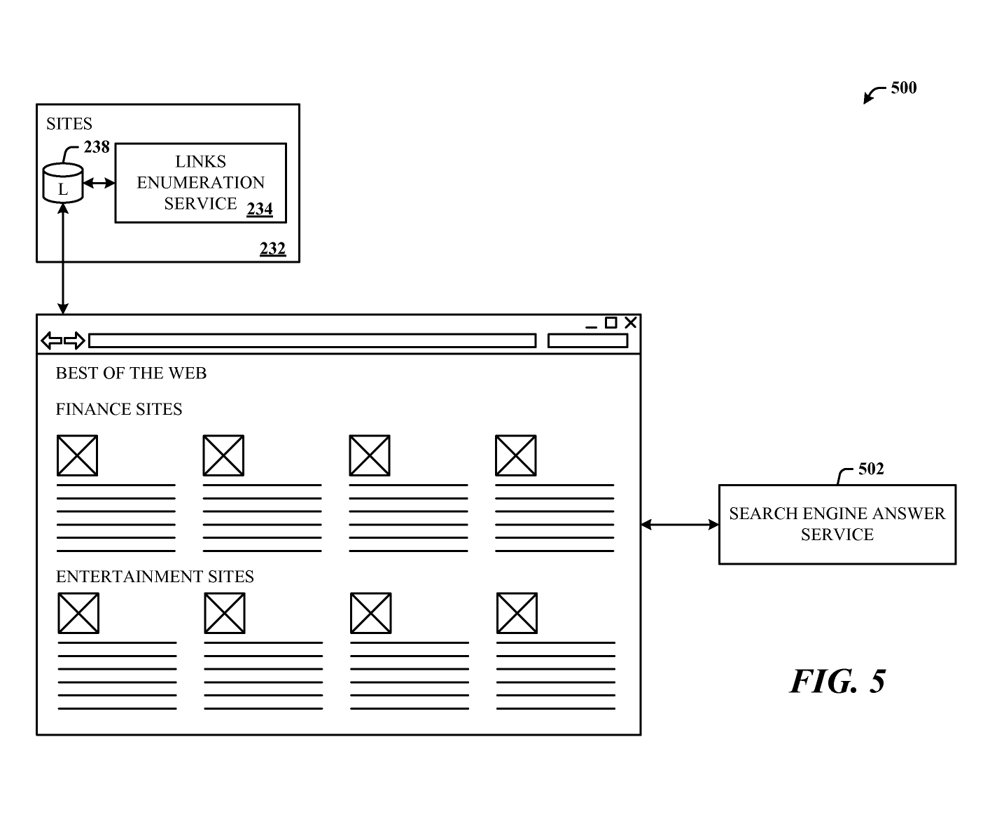

FIG. 5 illustrates a system 500 for generating website suggestions. The aggregated links database 238 and a search engine suggestions web service 502 can be used to suggest new sites related to the interests of the user.

With respect to a portable search profile, the local search component 108 can generate a taxonomy-based collection of attributes for a user based on the entities extracted out of his documents, people contacts, and website the user frequently visits. The collection of attributes with the specific values for the user can form the search profile. Each attribute can have specific values. For example, basic elements such as gender, age, primary geographic location, secondary/tertiary geographic locations, frequent travel destinations, common/shared music interests with personal network and from local media files, common/shared movie interests with personal network and from local media files, personal music interests, personal movie interests, etc.

The distinction between personal interests versus shared interests can be used in interesting ways when the user decides to opt-in to share this search profile with shopping sites (or any other category of sites that will find this useful in the future). With personal interests, the shopping sites can make recommendations specific to the user. With shared interests, the shopping sites can make recommendations specific to the group of people with which the user shared interests. This is useful in scenarios where a user may want to buy take-out food for a group of friends being hosted at home for dinner, for example. Other scenarios include where the user is shopping for tickets for a date-night, or the user wants to rent a movie on a night for a home theater experience.

The search profile capability also includes enabling the user to opt-in to expose user interests, history, favorites, and hot topics, for example. This can be facilitated via a security component for authorized and secure management of user information. The security component allows the subscriber to opt-in and opt-out of tracking information as well as personal information that may have been obtained at signup and utilized thereafter.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

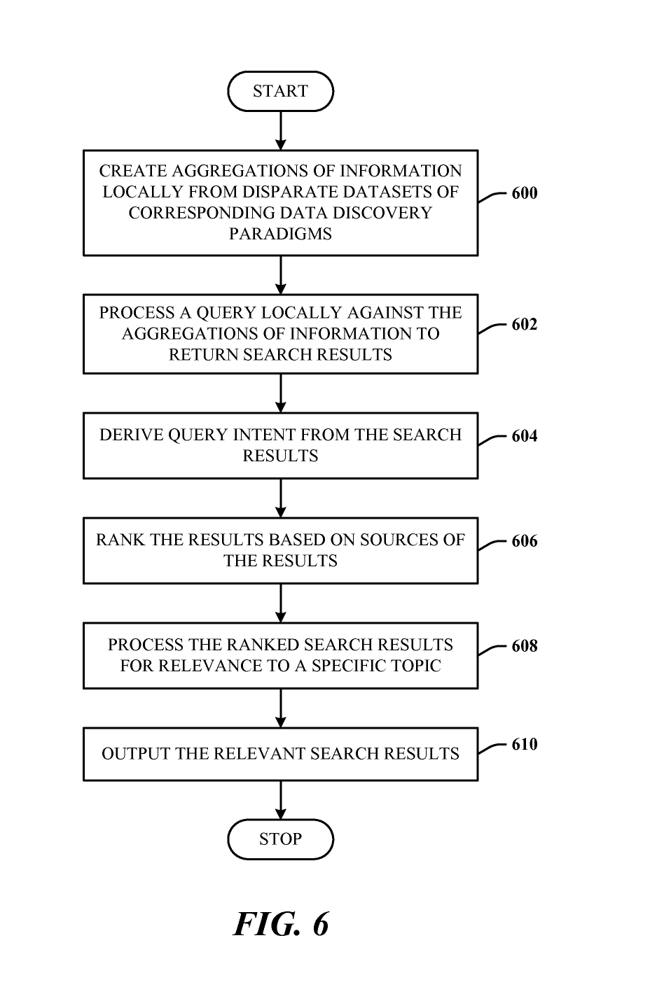

FIG. 6 illustrates a method in accordance with the disclosed architecture. At 600, aggregations of information are created locally from disparate datasets of corresponding data discovery paradigms. At 602, a query is processed locally against the aggregations of information to return search results. At 604, query intent is derived from the search results. At 606, the results are ranked based on sources of the results. At 608, the ranked search results are processed for relevance to a specific topic. At 610, the relevant search results are output.

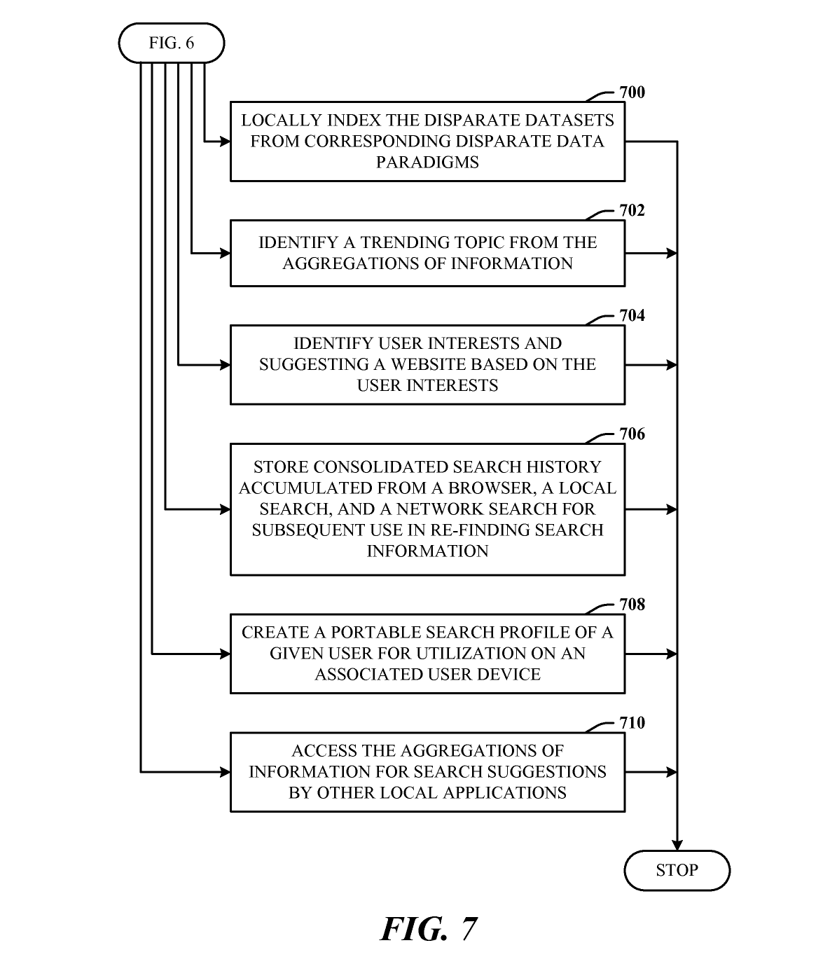

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the disparate datasets from corresponding disparate data paradigms are locally indexed. At 702, a trending topic is identified from the aggregations of information. At 704, user interests are identified and a website suggested based on the user interests. At 706, a consolidated search history accumulated from a browser, a local search, and a network search is stored for subsequent use in re-finding search information. At 708, a portable search profile of a given user is created for utilization on an associated user device. At 710, the aggregations of information are accessed for search suggestions by other local applications.

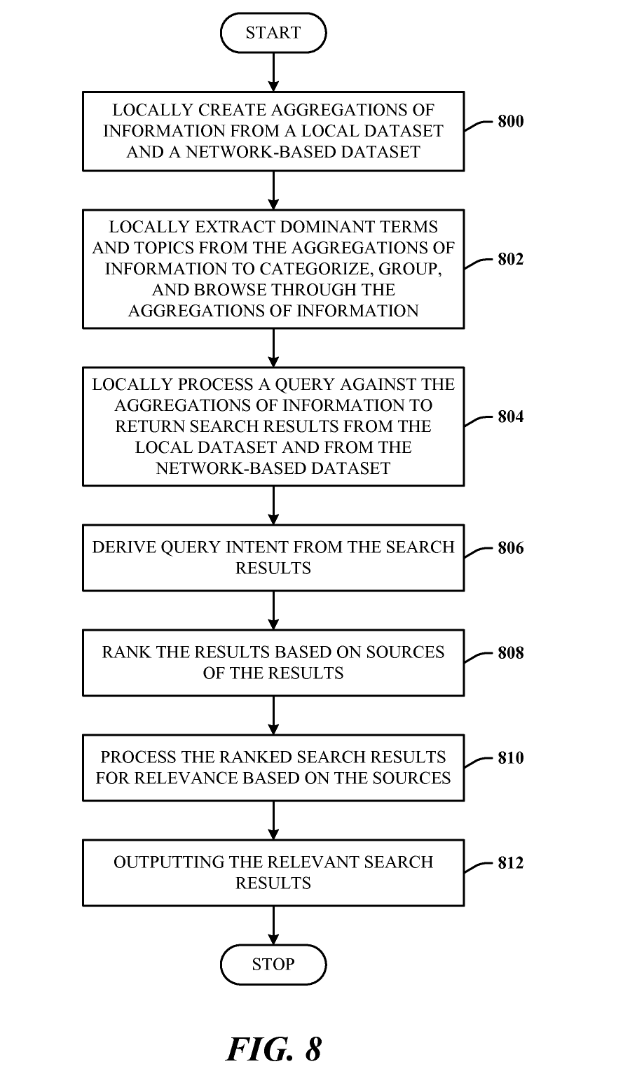

FIG. 8 illustrates an alternative method in accordance with the disclosed architecture. At 800, aggregations of information are created locally from a local dataset and a network-based dataset. At 802, dominant terms and topics are locally extracted from the aggregations of information to categorize, group, and browse through the aggregations of information. At 804, a query is locally processed against the aggregations of information to return search results from the local dataset and from the network-based dataset. At 806, query intent is derived from the search results. At 808, the results are ranked based on sources of the results. At 810, the ranked search results are processed for relevance based on the sources. At 812, the relevant search results are output.

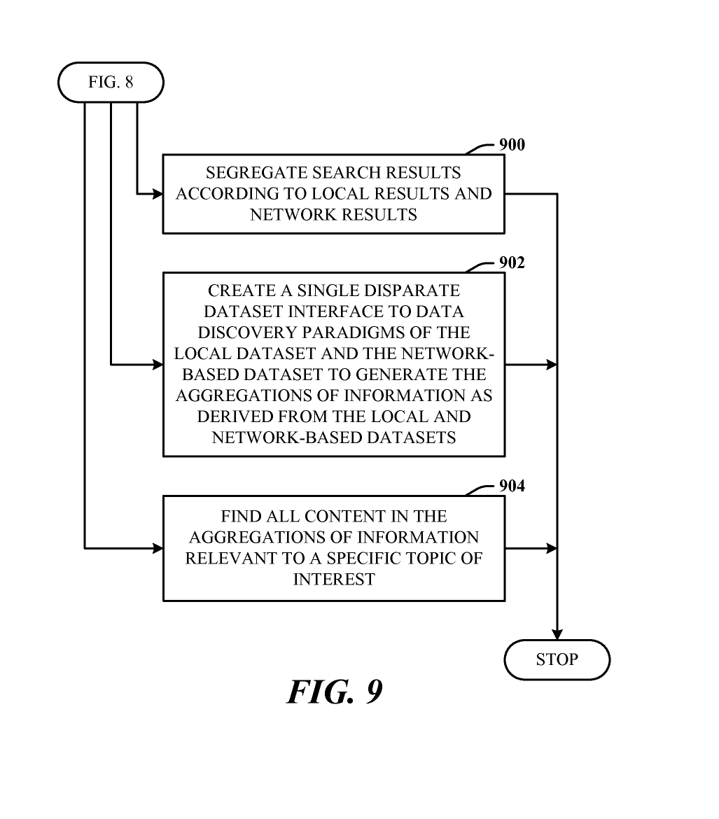

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, the search results are segregated according to local results and network results. At 902, a single disparate dataset interface is created to data discovery paradigms of the local dataset and the network-based dataset to generate the aggregations of information as derived from the local and network-based datasets. At 904, all content in the aggregations of information relevant to a specific topic of interest is found.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

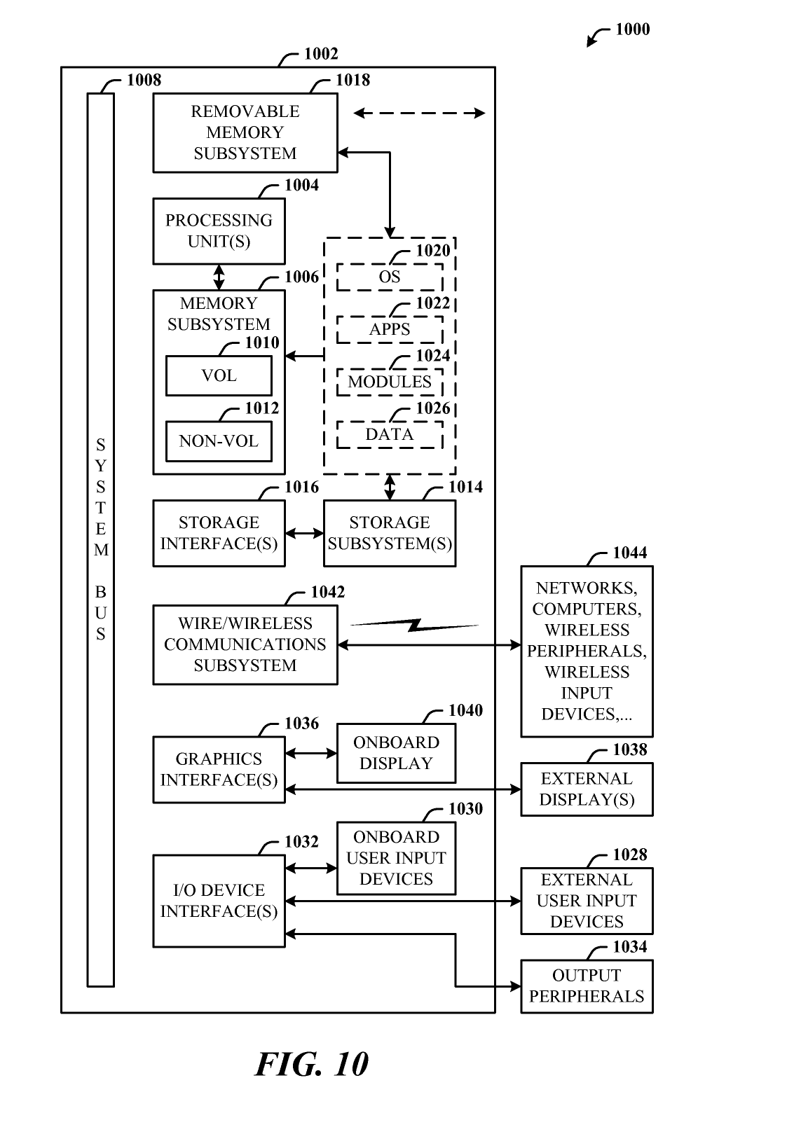

Referring now to FIG. 10, there is illustrated a block diagram of a computing system 1000 that executes a local search engine for query intent analysis, tanking, and relevance, as well as a global access to disparate datasets in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the system 200 of FIG. 2, entities and components of the system 300 of FIG. 3, entities and components of the system 400 of FIG. 4, entities and components of the system 500 of FIG. 5, and the methods represented by the flowcharts of FIGS. 6-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a global access component that is a unified interface to disparate data discovery paradigms, the global access component provides access to corresponding disparate datasets;
a local search component creates aggregations of information from the disparate datasets via the global access component and processes a query against the aggregations of information to return search results, the local search component performs intent analysis of the query to derive query intent, ranking of the search results, and relevance processing of the search results based on the query intent; and
a processor that executes computer-executable instructions associated with at least one of the global access component or the local search component.

2. The system of claim 1, wherein the local search component creates a unified index of data from the aggregations of information that include social aspects related to users and user data derived from the disparate datasets.

3. The system of claim 1, wherein the disparate data discovery paradigms include client-based paradigms and network-based paradigms.

4. The system of claim 1, wherein the search results include client-based results related to users and client-based data and network results related to users and network-based data of the users.

5. The system of claim 4, wherein the search results are segregated as local results and network results.

6. The system of claim 1, wherein the disparate data discovery paradigms relate to datasets associated with at least one of contacts, messages, documents, or websites.

7. The system of claim 1, wherein the local search component extracts dominant terms and topics to categorize, group, and browse through the datasets.

8. The system of claim 1, wherein the local search component identifies trending topics from a unified index of the aggregations of information.

9. The system of claim 1, wherein the local search component identifies user interests from the aggregations of information and suggests a website based on the user interests.

10. A method, comprising acts of:
creating aggregations of information locally from disparate datasets of corresponding data discovery paradigms;
processing a query locally against the aggregations of information to return search results;
deriving query intent from the search results;
ranking the results based on sources of the results;
processing the ranked search results for relevance to a specific topic;
outputting the relevant search results; and
utilizing a processor that executes instructions stored in memory to perform at least one of the acts of creating, processing, deriving, ranking, processing, or outputting.

11. The method of claim 10, further comprising locally indexing the disparate datasets from corresponding disparate data paradigms.

12. The method of claim 10, further comprising identifying a trending topic from the aggregations of information.

13. The method of claim 10, further comprising identifying user interests and suggesting a website based on the user interests.

14. The method of claim 10, further comprising storing consolidated search history accumulated from a browser, a local search, and a network search for subsequent use in re-finding search information.

15. The method of claim 10, further comprising creating a portable search profile of a given user for utilization on an associated user device.

16. The method of claim 10, further comprising accessing the aggregations of information for search suggestions by other local applications.

17. A method, comprising acts of:
locally creating aggregations of information from a local dataset and a network-based dataset;
locally extracting dominant terms and topics from the aggregations of information to categorize, group, and browse through the aggregations of information;
locally processing a query against the aggregations of information to return search results from the local dataset and from the network-based dataset;
deriving query intent from the search results;
ranking the results based on sources of the results;
processing the ranked search results for relevance based on the sources;
outputting the relevant search results; and
utilizing a processor that executes instructions stored in memory to perform at least one of the acts of creating, extracting, processing, deriving, ranking, processing, or outputting.

18. The method of claim 17, further comprising segregating the search results according to local results and network results.

19. The method of claim 17, further comprising creating a single disparate dataset interface to data discovery paradigms of the local dataset and the network-based dataset to generate the aggregations of information as derived from the local and network-based datasets.

20. The method of claim 17, further comprising finding all content in the aggregations of information relevant to a specific topic of interest.
